(19) United States
(12) Patent Application Publication
(10) Pub. No.: US 2009/0316739 A1
(43) Pub. Date: Dec. 24, 2009

(54) OPTICAL WAVELENGTH CONTROL CIRCUIT AND METHOD

(76) Inventor: YOSHITAKA YOKOYAMA, Tokyo (JP)

Correspondence Address: Mr. Jackson Chen, 6535 N. STATE HWY 161, IRVING, TX, 75039, US

(21) Appl. No.: 12/490,533

(22) Filed: Jun. 24, 2009

(30) Foreign Application Priority Data
Jun. 24, 2008 (JP) 164241/2008

(51) Int. Cl. H01S 3/13; H01S 3/04; H01S 3/00

(52) U.S. Cl. 372/32; 372/34; 372/38.09

(57) ABSTRACT

In an optical wavelength control circuit, an activation control circuit outputs an optical output setting signal to a laser unit to set its optical output, and simultaneously outputs a temperature setting signal and a wavelength setting signal. A temperature error detection circuit outputs a temperature error signal. A wavelength error detection circuit outputs a wavelength error signal. A control switching circuit receives the temperature error signal and the wavelength error signal, selectively outputs the temperature error signal as a control error signal in the activation operation, and selectively outputs the wavelength error signal as the control error signal in a steady-state operation after the activation operation. A steady-state error removing circuit removes a steady-state error contained in the control error signal and outputs a temperature controller control signal. A temperature controller driving circuit drives a temperature controller of the laser unit in accordance with the temperature controller control signal.

This application is based upon and claims the benefit of priority from Japanese patent application No. 2008-164241, filed on Jun. 24, 2008, the disclosure of which is incorporated herein in its entirety by reference.

### BACKGROUND OF THE INVENTION

The present invention relates to an optical wavelength control technique and, more particularly, to an optical wavelength control technique of stably controlling the wavelength of an optical output obtained from a laser unit.

Along with the recent progress of optical transmission technologies, various kinds of compact optical transmitters have been developed. Even DWDM (Dense Wavelength Division Multiplexing) communication which can obtain a large capacity by controlling individual optical transmission wavelengths to specific wavelengths and multiplexing them is pushing ahead with application of compact transceivers. Compact pluggable devices to be inserted/removed to/from a slot, like an optical transceiver such as an XFP (10 Gbit/s small Form-factor Pluggable) or an SFP (Small Form-factor Pluggable), are also making an effort afoot to introduce a light source having a wavelength monitoring function so as to attain a high wavelength stability and improve the wavelength multiplicity.

So far, large apparatuses commonly use the wavelength monitoring function. A large apparatus has a sufficient circuit space and can therefore do control using a signal processing circuit such as a DSP (Digital Signal Processor). To implement the same function as that of a large apparatus in a future optical transceiver such as an XFP or SFP, not only the optical component side but also the optical wavelength control circuit side requires miniaturization.

An optical wavelength control circuit used in such a compact optical transceiver has the following problems. As the first problem, if the control loop to control the wavelength of an optical output does not close, the error signal overshoots. This makes it difficult to stably switch temperature control to wavelength control. For example, if the wavelength monitor signal is periodical, the wavelength may stabilize not at a desired one but at another wavelength. The second problem is the difficulty of increasing the wavelength stabilization control accuracy.

These problems can be solved by, e.g., resetting a steady-state error at the start of control switching and then starting control after switching in this state using a signal processing circuit such as a DSP. However, since a signal processing circuit such as a DSP is necessary, component cost rises, and control becomes complex. It is also difficult to install a signal processing circuit in a current mainstream compact optical transceiver such as an XFP or SFP in view of performance.

The first problem may be solved by imparting an additional function of deciding control based on the environment around the apparatus, and when starting actual control after the decision, generating a delay time in accordance with the circumstances and the response characteristic of the circuit, as disclosed in Japanese Patent Laid-Open No. 2003-224329 (reference 1) (to be referred to as related art 1 hereinafter).

On the other hand, the second problem may be solved by introducing, to the LD wavelength control circuit, a wavelength control error signal between a wavelength monitor signal and a wavelength setting signal, as disclosed in Japanese Patent Laid-Open No. 2004-55974 (reference 2) (to be referred to as related art 2 hereinafter).

Japanese Patent Laid-Open No. 2003-198054 (reference 3) proposes a technique of constituting an output wavelength feedback control system using a monitor output from the output wavelength deviation detector of a light source unit by sharing the control circuit of a temperature feedback control system using a temperature detected by the temperature sensor of the light source unit (to be referred to as related art 3 hereinafter).

However, these related arts of optical wavelength control have the following problems.

In related art 1, the number of components increases, and control becomes complex, resulting in difficulty in miniaturization. Depending on the delay time setting condition, switching control may fail so the wavelength cannot stabilize to a desired one. First of all, the wavelength monitor signal is unstable during the delay time, resulting in an unstable output wavelength.

In related art 2, the optical wavelength control circuit compares an LD temperature monitor using a thermistor with a wavelength control error signal, thereby controlling the LD wavelength. However, since the temperature controller in the LD portion is not directly controlled using the wavelength control error signal, the temperature detection accuracy of the thermistor limits the wavelength stabilization accuracy. Use of a wavelength discriminator such as a wavelength filter makes it possible to easily detect a wavelength monitor signal at an accuracy higher by 10 times or more calculated in terms of temperature than in use of a thermistor. An optical transmitter having a wavelength control function needs this accuracy in some cases. To realize the required high wavelength stabilization accuracy, it is necessary to directly control the temperature controller using the wavelength control error signal. In this case, however, temperature control switching readily becomes unstable, as described in the first problem.

In related art 3, the temperature feedback control system and the output wavelength feedback control system share the deviation calculation circuit and the PID circuit. Since it is not possible to independently optimize the PID parameters of these control systems, neither control can obtain a high stability. Additionally, a target value setting circuit has a selector structure capable of switching two inputs so as to make a multiplexer switch between the detected temperature from the temperature sensor and the monitor output from the output deviation detector and appropriately perform the two kinds of control of the temperature feedback control system and the output wavelength feedback control system. When switching control, a number of such switching circuits must perform switching almost simultaneously. This is not easy in terms of both hardware and software and results in a large-scale complex circuit as a whole. Also, since the target value for wavelength control is set using the monitor output from the output deviation detector, it may be impossible to precisely adjust the wavelength to an arbitrary one.

### SUMMARY OF THE INVENTION

An exemplary object of the invention is to solve the above-described problems and provide an optical wavelength control circuit and optical wavelength control method capable of easily stably switching a control loop from temperature control to wavelength control without using any expensive complex circuit arrangement.

An optical wavelength control circuit according to an exemplary aspect of the invention includes an activation control circuit which outputs an optical output setting signal corresponding to a first optical output set value to a laser unit to set an optical output of the laser unit, and simultaneously outputs a temperature setting signal corresponding to a first temperature set value and a wavelength setting signal corresponding to a first wavelength set value as initial setting in an activation operation of the laser unit, a temperature error detection circuit which outputs a temperature error signal representing an error between the temperature setting signal and a temperature monitor signal representing a temperature of the laser unit, a wavelength error detection circuit which outputs a wavelength error signal representing an error between the wavelength setting signal and a wavelength monitor signal representing a wavelength of the optical output of the laser unit, a control switching circuit which receives the temperature error signal and the wavelength error signal, selectively outputs the temperature error signal as a control error signal in the activation operation, and selectively outputs the wavelength error signal as the control error signal in a steady-state operation after the activation operation, a steady-state error removing circuit which removes a steady-state error contained in the control error signal by integrating the control error signal, and outputs a temperature controller control signal, and a temperature controller driving circuit which drives a temperature controller of the laser unit in accordance with the temperature controller control signal, thereby controlling the wavelength of the optical output of the laser unit.

An optical wavelength control method according to another exemplary aspect of the invention includes the steps of outputting an optical output setting signal corresponding to a first optical output set value to a laser unit to set an optical output of the laser unit, and simultaneously outputting a temperature setting signal corresponding to a first temperature set value and a wavelength setting signal corresponding to a first wavelength set value as initial setting in an activation operation of the laser unit, outputting a temperature error signal representing an error between the temperature setting signal and a temperature monitor signal representing a temperature of the laser unit, outputting a wavelength error signal representing an error between the wavelength setting signal and a wavelength monitor signal representing a wavelength of the optical output of the laser unit, receiving the temperature error signal and the wavelength error signal, selectively outputting the temperature error signal as a control error signal in the activation operation, and selectively outputting the wavelength error signal as the control error signal in a steady-state operation after the activation operation, removing a steady-state error contained in the control error signal by integrating the control error signal, and outputting a temperature controller control signal, and driving a temperature controller of the laser unit in accordance with the temperature controller control signal, thereby controlling the wavelength of the optical output of the laser unit.

### BRIEF DESCRIPTION OF THE DRAWINGS

FIG. 1 is a block diagram showing the arrangement of an optical wavelength control circuit according to an exemplary embodiment of the present invention;

FIG. 2 is a circuit diagram showing an example of the arrangement of a steady-state error removing circuit;

FIG. 3 is a flowchart illustrating the laser unit activation operation of the optical wavelength control circuit according to the exemplary embodiment of the present invention;

FIG. 4 is a graph showing the performance characteristics of an optical output and wavelength;

FIG. 5 is a block diagram showing an arrangement of a laser unit;

FIG. 6 is a block diagram showing another arrangement of the laser unit; and

FIG. 7 is a graph showing examples of behavior of optical outputs and optical wavelengths.

### EXEMPLARY EMBODIMENT

An exemplary embodiment of the present invention will now be described with reference to the accompanying drawings.

### Arrangement of Exemplary Embodiment

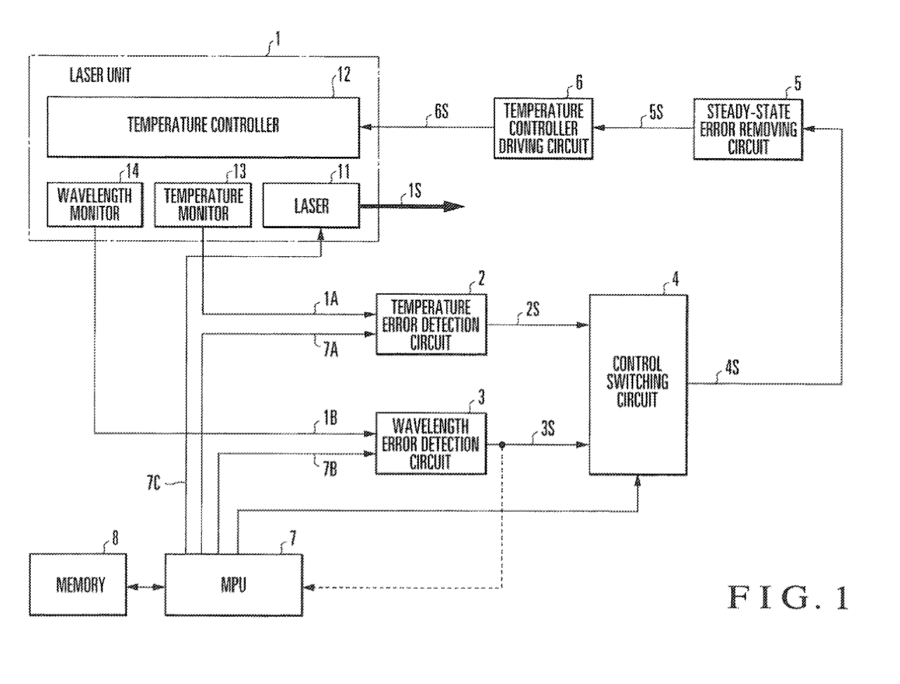

An optical wavelength control circuit according to an exemplary embodiment of the present invention will be explained with reference to FIG. 1.

The optical wavelength control circuit shown in FIG. 1 controls a laser unit 1 including a laser 11, temperature controller 12, temperature monitor 13, and wavelength monitor 14.

The laser unit 1 may use, as the laser 11, a common semiconductor laser which oscillates in the single axial mode, and a Peltier device as the temperature controller 12. The wavelength monitor 14 may be of a type which causes a photodiode (to be referred to as a PD hereinafter) to receive light obtained by making forward output light or backward output light from the laser 11 pass through a wavelength filter such as a Fabry-Perot etalon and outputs the photocurrent from the PD as a wavelength monitor signal 1B. The temperature monitor 13 can be a thermistor that changes the resistance component in accordance with the temperature of the laser 11.

Assume that in a steady state, the bias current of the laser 11 is controlled to obtain a predetermined photocurrent from an optical output monitor PD (not shown) so that a predetermined optical output is obtain as an optical output signal 1S. Hence, the wavelength monitor 14 outputs a monitor signal normalized by the optical output under the fixed optical output control.

As main circuit portions, the optical wavelength control circuit in FIG. 1 includes a temperature error detection circuit 2, wavelength error detection circuit 3, control switching circuit 4, steady-state error removing circuit 5, temperature controller driving circuit 6, MPU (Micro Processor Unit/activation control circuit) 7, and memory 8.

The wavelength error detection circuit 3 detects the difference between the wavelength monitor signal 1B output from the wavelength monitor 14 and a wavelength setting signal 7B output from the MPU 7 via a DAC (Digital Analog Converter) (not shown) in or outside the MPU 7, and outputs a wavelength error signal 3S proportional to the difference. When the control switching circuit 4 selects wavelength control, the wavelength error signal 3S becomes a control error signal 4S and controls the temperature controller 12 of the laser unit 1 via the steady-state error removing circuit 5 and the temperature controller driving circuit 6.

The wavelength error detection circuit 3 can be formed from, e.g., a difference amplifying circuit using a common operational amplifier. A very large gain is generally used as the gain of the difference amplifying circuit for final wavelength control so as to eliminate the steady-state error of wavelength control. In this exemplary embodiment, it is unnecessary to use a very large gain because the steady-state error removing circuit 5 removes the steady-state error. For this reason, a relatively small gain of, e.g., 1 to 10 can be set as the gain of the difference amplifying circuit of the wavelength error detection circuit 3, although it depends on the actual wavelength control loop. This allows to hold the value of the wavelength error signal 3S within a predetermined range without overshooting and achieve stable wavelength control even if the wavelength control loop is not closed.

Similarly, the temperature error detection circuit 2 detects the difference between a temperature monitor signal 1A output from the temperature monitor 13 and a temperature setting signal 7A output from the MPU 7 via the DAC (not shown) in or outside the MPU 7, and outputs a temperature error signal 2S proportional to the difference. When the control switching circuit 4 selects temperature control, the temperature error signal 2S becomes the control error signal 4S and controls the temperature controller 12 of the laser unit 1 via the steady-state error removing circuit 5 and the temperature controller driving circuit 6.

The temperature error detection circuit 2 can be formed from, e.g., a difference amplifying circuit using a common operational amplifier. A very large gain is generally used as the gain of the difference amplifying circuit for final temperature control so as to eliminate the steady-state error of temperature control. In this exemplary embodiment, it is unnecessary to use a very large gain because the steady-state error removing circuit 5 removes the steady-state error. For this reason, a relatively small gain of, e.g., 1 to 10 can be set as the gain of the difference amplifying circuit of the temperature error detection circuit 2, although it depends on the actual temperature control loop. This allows to hold the value of the temperature error signal 2S within a predetermined range without overshooting and realize stable temperature control even if the temperature control loop is not closed.

The control switching circuit 4 can be a common analog switch. As will be described later, not wavelength control but temperature control is necessary at the time of activating the laser unit 1. Hence, the control switching circuit 4 is adjusted to select the temperature error detection circuit 2 in the power-off state. That is, the temperature error signal 2S and the control error signal 4S are normally closed.

The steady-state error removing circuit 5 removes the steady-state error generated in temperature control and wavelength control by integrating the control error signal 4S from the control switching circuit 4. As described above, a relatively small gain is set for the temperature error detection circuit 2 in temperature control or the wavelength error detection circuit 3 in wavelength control. The steady-state error generated by this is suppressed by introducing the common steady-state error removing circuit 5 on the output side of the control switching circuit 4. This enables stable temperature control or wavelength control independently of the operating temperature environment of the laser unit 1.

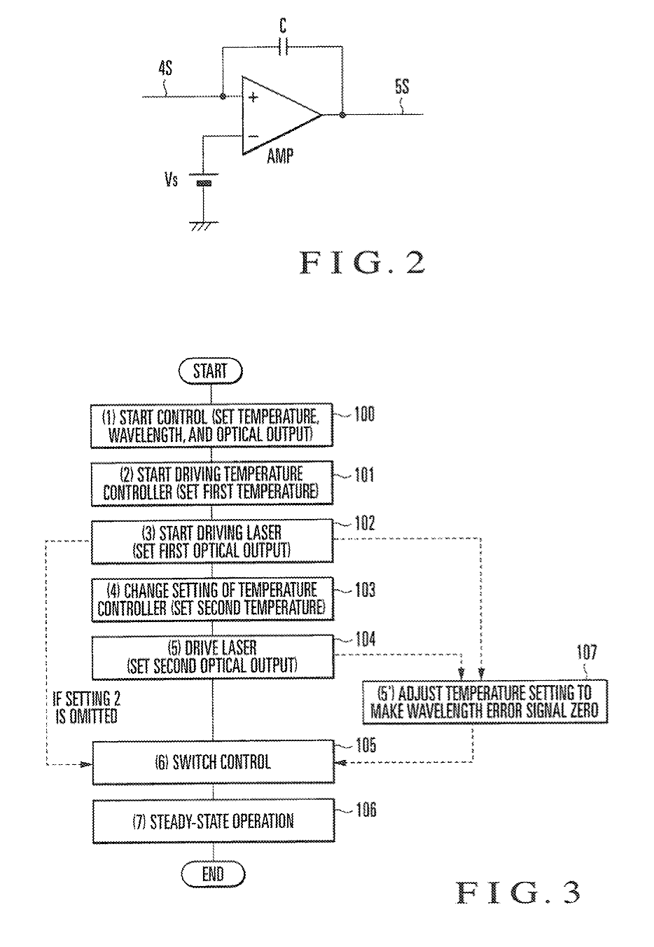

The steady-state error removing circuit 5 can be a general integration circuit including an operational amplifier AMP, capacitive element C, and reference voltage Vs, as shown in FIG. 2, which can remove the steady-state error by the circuit arrangement including a few components.

In the steady-state error removing circuit 5 using an analog circuit, the control error signal overshoots if the control loop is not closed. In the optical wavelength control circuit of this exemplary embodiment, however, the control switching circuit 4 always connects the steady-state error removing circuit 5 to the wavelength error control or temperature error control. Except immediately after the laser unit 1 has been activated, the control loop is always closed. For this reason, the control error signal 4S does not overshoot in the subsequent normal operation. This permits stable switching control.

The temperature controller driving circuit 6 generates a temperature controller driving signal 6S having a current value or a voltage value corresponding to a temperature controller control signal 5S from the steady-state error removing circuit 5 and outputs it to the temperature controller 12 of the laser unit 1, thereby driving the temperature controller 12.

The MPU 7 reads out a program stored in it or the memory 8 and operates, thereby controlling the units of the optical wavelength control circuit. More specifically, the MPU 7 performs optical output setting and drive control of the laser 11 of the laser unit 1, output control of the temperature setting signal 7A to the temperature error detection circuit 2, output control of the wavelength setting signal 7B to the wavelength error detection circuit 3, and input switching control of the control switching circuit 4.

### Operation of Exemplary Embodiment

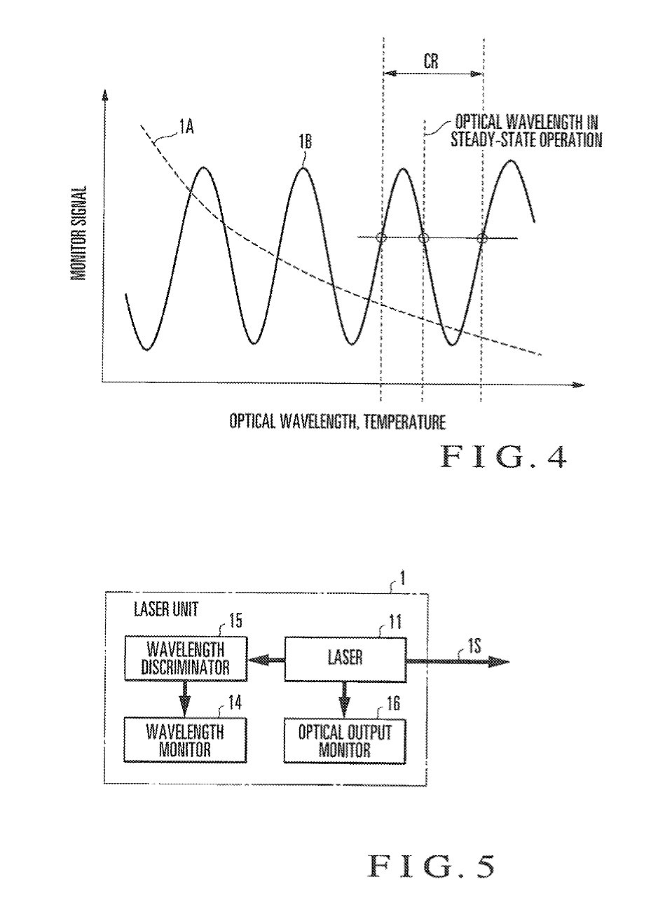

The operation of the optical wavelength control circuit according to the exemplary embodiment of the present invention will be described next with reference to FIGS. 3 and 4.

As shown in FIG. 3, in the control start step (1), the optical wavelength control circuit causes the MPU 7 to read out, from the memory 8, appropriate set values of the temperature, wavelength, and optical output of the laser unit 1 and, in this case, a first temperature setting, first wavelength setting, and first optical output setting, and output the temperature setting signal 7A, the wavelength setting signal 7B, and an optical output setting signal 7C corresponding to the set values to the temperature error detection circuit 2, the wavelength error detection circuit 3, and the laser 11, respectively (step 100). At this time, the temperature controller 12 and the laser 11 are not driven yet.

In the next temperature controller driving start step (2), the optical wavelength control circuit causes the temperature error detection circuit 2 to detect the error between the temperature monitor signal 1A from the temperature monitor 13 and the first temperature setting set by the temperature setting signal 7A, and causes the control switching circuit 4 to select the temperature error signal 2S representing the error and output it to the steady-state error removing circuit 5. A temperature control loop including the temperature monitor 13, temperature error detection circuit 2, control switching circuit 4, steady-state error removing circuit 5, temperature controller driving circuit 6, and temperature controller 12 thus starts controlling the temperature controller 12.

At this time, the control switching circuit 4 switches the control loop in advance to connect the temperature error detection circuit 2 to the steady-state error removing circuit 5. Since the temperature error detection circuit 2 is a normally closed circuit, special setting by the MPU 7 and the like is unnecessary upon activating the laser unit 1. In this example, the laser temperature to determine the initial operating wavelength of the laser 11 is controlled to a predetermined value in the optical output OFF state.

Upon activating the laser unit 1, control starts in a state in which the temperature controller control signal 5S output from the steady-state error removing circuit 5 is fixed at the maximum or minimum value. When a thermistor is used as the temperature monitor 13, the temperature monitor signal 1A obtained by converting a change in its resistance into a voltage monotonically decreases with respect to the temperature without discontinuities, as shown in FIG. 4. For this reason, wavelength control in the activation operation never runs away so the temperature is fed back to the desired first temperature setting.

After that, in the laser driving start step (3), the optical wavelength control circuit causes the MPU 7 to control the laser unit 1 and start driving the laser 11 based on the first optical output set value (step 102). If the first temperature setting and the first optical output setting are used as the set values in the steady-state operation after the activation operation (if setting 2 is omitted), the process advances to the control switching step (6) in FIG. 3.

To reduce the wavelength change amount at the time of activation, the process may advance to the second temperature setting step (4). The MPU 7 reads out a second temperature setting from the memory 8 and outputs it to the temperature error detection circuit 2 by the temperature setting signal 7A, thereby changing the temperature setting from the first temperature setting to the second temperature setting (step 103). Then, in the second optical output setting step (5), the MPU 7 reads out a second optical output setting from the memory 8 and sets it in the laser 11 by the optical output setting signal 7C (step 104). This enables to change the optical output after changing the temperature setting and reduce the wavelength change amount at the time of activation.

In a semiconductor laser, the optical wavelength is generally prolonged with respect to the driving bias current. Hence, the second temperature setting that is a setting for a high bias uses a temperature lower than the first temperature setting. At this time, the set value of the second temperature setting is decided to allow to, in the control switching step (6), set an actual wavelength to a desired wavelength to operate in the steady-state operation step (7). More specifically, if the wavelength monitor signal characteristic exhibits periodicity with respect to the optical output wavelength, as shown in FIG. 4, the temperature is set in a capture range CR including a slope to control. Since the temperature is almost controlled to the final controlled temperature before control switching, the temperature controller control signals 5S before and after control switching have close convergence values. This enables stable control switching.

Before the control switching step (6), a step of causing the MPU 7 to monitor the wavelength error signal 3S output from the wavelength error detection circuit 3 and adjust the value of the temperature setting signal 7A to make the wavelength error signal 3S almost zero (step 107) may be introduced as the temperature setting adjustment step (5′). Since temperature control is being executed, the temperature error signal 2S remains zero as long as stable control is ensured even if the temperature setting signal 7A is adjusted in the temperature setting adjustment step (5′).

Since the temperature error signal 2S and the wavelength error signal 3S have almost the same value, the optical output and optical wavelength noise (fluctuation) upon control switching are suppressed to very small values.

FIG. 3 indicates a wavelength variation that occurs when the temperature setting is finely adjusted in the temperature setting adjustment step (5′), and the control switching step (6) is then executed. At the control switching step (6), a fluctuation in the wavelength monitor signal, i.e., the output wavelength itself as described in the above related arts is very small.

Note that the temperature setting adjustment step (5′) is executed at any point between the activation operation up to the laser driving start step (3) and the control switching step (6). Hence, if the second temperature setting step (4) and the second optical output setting step (5) in FIG. 3 are not executed, the temperature setting adjustment step (5′) may be executed after the laser driving start step (3).

After the control switching step (6), temperature control of the laser 11 by the temperature monitor 13 switches to wavelength control by the wavelength monitor 14. The process advances to the steady-state operation step (7) (step 106). Note that the control system switching timing is not defined by any special condition. Switching is done when overshoot or undershoot of the temperature monitor signal 1A which occurs immediately after the start of temperature control has converged, and the temperature control has stabilized. Switching may be performed at a timing when the temperature monitor signal 1A or the temperature error signal 2S monitored by the MPU 7 has fallen within an adequate range. Alternatively, the switching timing may be set at a point when the MPU 7 has detected the elapse of a predetermined time from the start of temperature control.

In the steady-state operation step (7), the wavelength error detection circuit 3 detects the error between the wavelength monitor signal 1B from the wavelength monitor 14 and the wavelength setting set by the wavelength setting signal 7B. The control switching circuit 4 selects the wavelength error signal 3S representing the error and outputs it to the steady-state error removing circuit 5. A wavelength control loop including the wavelength monitor 14, wavelength error detection circuit 3, control switching circuit 4, steady-state error removing circuit 5, temperature controller driving circuit 6, and temperature controller 12 thus starts controlling the temperature controller 12 (step 106).

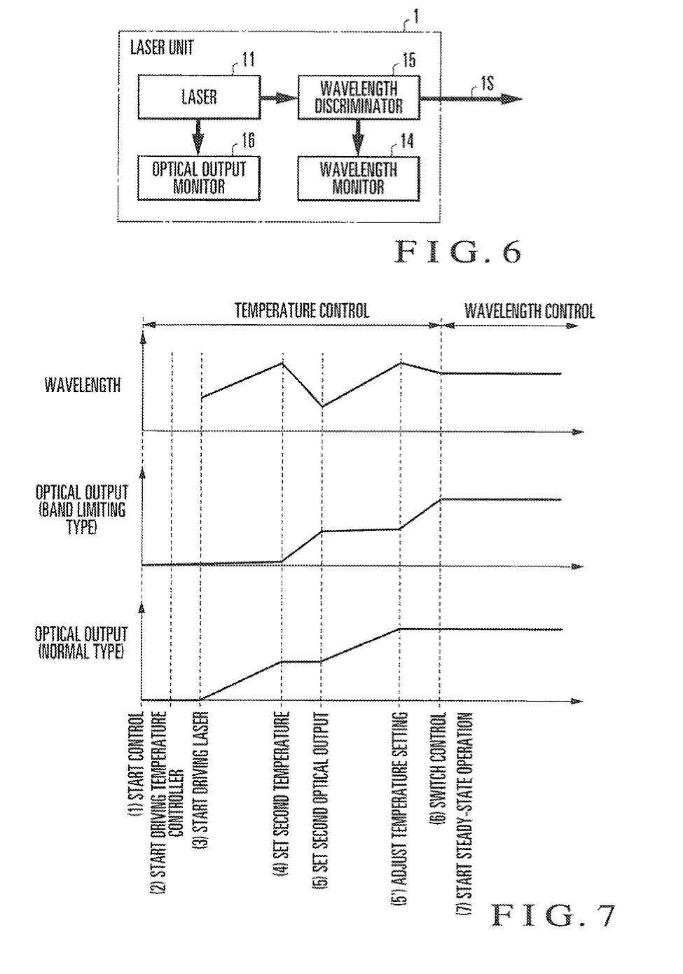

The laser unit 1 is of a normal type shown in FIG. 5 or a band limiting type shown in FIG. 6. In the normal type, signals are output to an optical output monitor 16 and a wavelength discriminator 15 separately from the optical output signal 1S of the laser 11. The wavelength monitor 14 detects a wavelength from the optical output discriminated by the wavelength discriminator 15. The optical output monitor 16 detects an output level from the optical output signal 1S from the laser 11. This allows to obtain a predetermined optical output independently of the optical output wavelength.

On the other hand, the band limiting type has a function of causing an optical filter arranged forward of the laser 11 to limit the light modulation band. The optical filter is used as the wavelength discriminator 15 for the wavelength monitor. The wavelength monitor 14 detects a wavelength from the optical output discriminated by the wavelength discriminator 15. The optical output monitor 16 detects an output level from the optical output from the laser 11.

In the band limiting type shown in FIG. 6, even when the bias current of the laser 11 is controlled to obtain a predetermined optical output monitor signal, the optical output intensity changes depending on the optical wavelength setting because of the influence of the optical filter arranged in front of the laser. For this reason, the behavior of the optical output upon activation changes.

FIG. 7 shows examples of behavior of an optical wavelength common to both types and their optical outputs.

In the normal type, when the optical output setting rises, the optical output monotonically increases. Even when the temperature setting is changed, the optical output does not change. To the contrary, in the band limiting type, a change in the optical output wavelength which occurs upon raising the optical output setting generates an effect of canceling the increase in the optical output by the transmission loss of the optical filter so the optical output does not largely change. When the temperature setting is changed, only the influence of the optical filter shows up, and the optical output intensity may largely change.

In this exemplary embodiment, the temperature setting and the wavelength setting can freely be set independently. The activation method of this exemplary embodiment is applicable to both the normal type and the band limiting type. It is possible to suppress the total wavelength change and reduce the wavelength change and switching noise in the control switching step (6).

### Effects of Exemplary Embodiment

As described above, according to this exemplary embodiment, the temperature error detection circuit 2 and the wavelength error detection circuit 3 are independently provided. The control switching circuit 4 selectively inputs, to the steady-state error removing circuit 5, one of the temperature error signal 2S and the wavelength error signal 3S from these error detection circuits, thereby driving the temperature controller 12.

This allows the MPU 7 to freely set the temperature setting and the wavelength setting independently. The wavelength error signal 3S or the temperature error signal 2S can have a value within a predetermined range regardless of the state of the control switching circuit 4, i.e., open/close of the control loop. Upon switching the control loop from the temperature control loop to the wavelength control loop in the activation operation of the laser unit 1, it is therefore possible to reduce the risk of controlling to a wrong wavelength and minimize noise generated in switching. This implements stable control loop switching.

The steady-state error removing circuit 5 outputs different temperature controller driving signals for a predetermined error signal depending on operating environment. This enables stable wavelength control to a desired set temperature or set wavelength.

Especially, if the steady-state error removing circuits 5 are individually provided before the control switching circuit 4, and for example, between the control switching circuit 4 and the temperature error detection circuit 2 and wavelength error detection circuit 3, changes in the temperature error signal 2S and the wavelength error signal 3S delay due to the integration operation of each steady-state error removing circuit 5. The delays in changes generate errors in the temperature error signal 2S and the wavelength error signal 3S, resulting in noise upon switching the control loop.

In the exemplary embodiment, however, the steady-state error removing circuit 5 is arranged at the succeeding stage of the control switching circuit 4. Hence, the change delay in the control error signal 4S caused by the integration operation of the steady-state error removing circuit 5 does not affect the control loop switching. It is therefore possible to minimize noise upon switching and implement stable control loop switching.

Since the steady-state error removing circuit 5 removes the steady-state error, the temperature error detection circuit 2 and the wavelength error detection circuit 3 need not use very large gains. Since relatively small gains can be set, the temperature error signal 2S or the wavelength error signal 3S can hold a value within a predetermined range without overshoot even when the temperature control loop or wavelength control loop is not closed. This implements stable temperature control.

In the exemplary embodiment, after the activation operation of the laser unit 1, the control loop is switched from the temperature control loop to the wavelength control loop. This makes it possible to drive and control the temperature controller 12 based on not a temperature monitor output having a small change width with respect to a wavelength change but a wavelength monitor output having a large change width with respect to a wavelength change. It is therefore possible to accurately control the wavelength of the optical output signal 1S.

In the exemplary embodiment, advanced control using a DSP and the like is unnecessary, and inexpensive compact common analog components suffice. This enables to form an inexpensive compact wavelength control circuit capable of realizing stable switching control and a high wavelength control accuracy, and therefore form an inexpensive compact optical transmitter or optical transceiver including a laser unit.

As described above, according to the present invention, the temperature setting and the wavelength setting can freely be set independently. When switching the control loop from the temperature control loop to the wavelength control loop in the activation operation of the laser unit, it is possible to reduce the risk of controlling to a wrong wavelength and minimize noise generated in switching. This implements stable control loop switching. Additionally, stable wavelength control to a desired set temperature or set wavelength can be done. Also it is possible to drive and control the, temperature controller based on a wavelength monitor output having a large change width with respect to a wavelength change, and accurately control the wavelength of the optical output. It is also possible to form an inexpensive compact wavelength control circuit for realizing stable switching control and a high wavelength control accuracy without using any expensive complex circuit arrangement such as a DSP, and therefore form an inexpensive compact optical transmitter or optical transceiver including a laser unit.

The applicability of the present invention includes an optical transmitter, and an optical transceiver in a network apparatus.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An optical wavelength control circuit comprising:
an activation control circuit which outputs an optical output setting signal corresponding to a first optical output set value to a laser unit to set an optical output of the laser unit, and simultaneously outputs a temperature setting signal corresponding to a first temperature set value and a wavelength setting signal corresponding to a first wavelength set value as initial setting in an activation operation of the laser unit;
a temperature error detection circuit which outputs a temperature error signal representing an error between the temperature setting signal and a temperature monitor signal representing a temperature of the laser unit;
a wavelength error detection circuit which outputs a wavelength error signal representing an error between the wavelength setting signal and a wavelength monitor signal representing a wavelength of the optical output of the laser unit;
a control switching circuit which receives the temperature error signal and the wavelength error signal, selectively outputs the temperature error signal as a control error signal in the activation operation, and selectively outputs the wavelength error signal as the control error signal in a steady-state operation after the activation operation;
a steady-state error removing circuit which removes a steady-state error contained in the control error signal by integrating the control error signal, and outputs a temperature controller control signal; and
a temperature controller driving circuit which drives a temperature controller of the laser unit in accordance with the temperature controller control signal, thereby controlling the wavelength of the optical output of the laser unit.

2. The circuit according to claim 1, wherein said activation control circuit is configured to output a temperature setting signal corresponding to a second temperature set value and simultaneously output an optical output setting signal corresponding to a second optical output set value to the laser unit to set the optical output of the laser unit from the initial setting up to a start of the steady-state operation.

3. The circuit according to claim 1, wherein said activation control circuit is configured to adjust the temperature set value of the temperature setting signal to make the wavelength error signal zero from the initial setting up to a start of the steady-state operation.

4. The circuit according to claim 2, wherein said activation control circuit is configured to adjust the temperature set value of the temperature setting signal to make the wavelength error signal zero from the setting of the second temperature set value and the second optical output set value up to the start of the steady-state operation.

5. An optical wavelength control method comprising the steps of:
outputting an optical output setting signal corresponding to a first optical output set value to a laser unit to set an optical output of the laser unit, and simultaneously outputting a temperature setting signal corresponding to a first temperature set value and a wavelength setting signal corresponding to a first wavelength set value as initial setting in an activation operation of the laser unit;
outputting a temperature error signal representing an error between the temperature setting signal and a temperature monitor signal representing a temperature of the laser unit;
outputting a wavelength error signal representing an error between the wavelength setting signal and a wavelength monitor signal representing a wavelength of the optical output of the laser unit;
receiving the temperature error signal and the wavelength error signal, selectively outputting the temperature error signal as a control error signal in the activation operation, and selectively outputting the wavelength error signal as the control error signal in a steady-state operation after the activation operation;
removing a steady-state error contained in the control error signal by integrating the control error signal, and outputting a temperature controller control signal; and
driving a temperature controller of the laser unit in accordance with the temperature controller control signal, thereby controlling the wavelength of the optical output of the laser unit.

6. The method according to claim 5, wherein
the step of outputting the optical output setting signal comprises, from the initial setting up to a start of the steady-state operation, the steps of:
outputting a temperature setting signal corresponding to a second temperature set value; and
outputting an optical output setting signal corresponding to a second optical output set value to the laser unit to set the optical output of the laser unit.

7. The method according to claim 5, wherein
the step of outputting the optical output setting signal comprises, from the initial setting up to a start of the steady-state operation, the step of adjusting the temperature set value of the temperature setting signal to make the wavelength error signal zero.

8. The method according to claim 6, wherein
the step of outputting the optical output setting signal comprises, from the setting of the second temperature set value and the second optical output set value up to the start of the steady-state operation, the step of adjusting the temperature set value of the temperature setting signal to make the wavelength error signal zero.
